(19) United States
(12) Patent Application Publication
(10) Pub. No.: US 2017/0223785 A1
(43) Pub. Date: Aug. 3, 2017

(54) ARRANGEMENT OF LED ELEMENTS CONNECTED TO A STEP DRIVER

(71) Applicant: PHILIPS LIGHTING HOLDING B.V., EINDHOVEN (NL)

(72) Inventors: RALPH KURT, EINDHOVEN (NL); HENRICUS MARIUS JOSEPH MARIA KAHLMAN, EINDHOVEN (NL)

(21) Appl. No.: 15/501,061

(22) PCT Filed: Aug. 4, 2015
(86) PCT No.: PCT/EP2015/067990

§ 371 Date: Feb. 1, 2017

(30) Foreign Application Priority Data
Aug. 7, 2014 (EP) 14180220.7

(51) Int. Cl. H05B 33/08; H02M 3/157

(52) U.S. Cl. CPC H05B 33/083; H05B 33/0833; H05B 33/0839; H02M 3/157; H05B 33/0842; H05B 33/0815

(57) ABSTRACT

A lighting device and a method of operating a lighting device are described. A plurality of LED elements (12) are electrically connected to form at least two groups (1, 2, 3). Each group of LED elements comprises at least one string (30) of at least two LED elements (12) electrically connected in series. A step driver circuit (14) supplies electrical power to the LED elements (12). The step driver circuit (14) operates the groups (1, 2, 3) of LED elements (12) from a periodically varying supply voltage V by activating the groups selectively depending on a momentary voltage value of the supply voltage V. The LED elements (12) are arranged on a carrier (26) forming an arrangement pattern. In order to achieve an improved optical appearance in particular in a dimmed state, the LED elements (12) of at least one of the groups (1, 2, 3) are located on the carrier (26) so as to be evenly distributed over the arrangement pattern.

### TECHNICAL FIELD

The invention relates to a lighting device and to a method of operating a lighting device. More specifically, the invention relates to operation of groups of LED elements selectively activated depending on a momentary voltage value of a periodically varying supply voltage.

### BACKGROUND OF THE INVENTION

Lighting devices with LED elements are becoming more and more popular. In particular for lighting devices supplied with mains power, different types of power supply circuits are known which convert the mains electrical power, supplied e.g. as sinusoidal varying voltage with 110 or 230 Vᵣₘₛ and a frequency of 50 or 60 Hz, to current and voltage values suited for operation of LEDs.

While many of such power supplies comprise voltage conversion circuits to obtain constant DC LED operating voltages from the periodically varying mains supply voltage, the concept of a step driver, also referred to as a tapped linear driver (TLD) allows directly driving LED elements from an alternating current power supply. Within a TLD architecture, the LED elements are electrically connected to form separate groups which are connected to a step driver circuit. The step driver circuit is supplied with a periodically varying supply voltage, such as rectified mains, and selectively activates said groups depending on a momentary voltage value of the supply voltage.

US 2014/0210362 A1 discloses an illuminating apparatus using semiconductor light emitting elements comprising more than two LED groups which are serially connected, each being capable of radiating light in a half cycle of an AC input voltage. The first LED group is preferably arranged first, and then the others are arranged one after another in consecutive order in a radially outward direction from the center towards the edge of the substrate. With this layout, in a half cycle of the AC voltage, the first LED group located upstream of the current flow path is first lit up, and then the other groups up to the fourth LED group located downstream of the current flow path are lit up. Therefore, the lighting process gradually proceeds in the direction from the center towards the edge of the substrate US 2013/0278163 A1 describes a system and method for controlling LED segments to provide lighting effects. A single board light engine includes driver electronics and multiple LED segments. The driver electronics include an AC to AC step driver that selectively powers the LED segments by controlling tap points between the LED segments as the AC wave form goes from zero crossover to maximum voltage and returns to zero crossover. To provide center-to-edge brightness, the LED segments have different positions on the board. In one example with three LED segments, the first LED segment is located at approximately the center of the board, the second LED segment at least partially surrounds the first LED segment and is located further out from the center, and the third LED segment at least partially surrounds the second LED segment and is located furthest from the center. In this manner, center-to-edge brightness may be provided at power-on and while dimming, i. e. if the shape of the AC wave form is controlled by a dimmer.

### SUMMARY OF THE INVENTION

It may be considered an object to provide a lighting device and operating method with improved optical appearance, in particular in a dimmed state.

This object is achieved by a lighting device according to claim 1 and an operating method according to claim 15. Dependent claims refer to preferred embodiments of the invention.

The inventors have considered the optical appearance of a lighting device with a step driver circuit and a plurality of groups of LED elements. As the step driver circuit activates the groups selectively depending on a momentary voltage value of the supply voltage, the different groups of LED elements will not all continue to stay activated, i. e. be supplied with operating voltage and current to emit light, during the entire period of the periodically varying supply voltage. During time periods where the momentary voltage value is not sufficient to drive all LED elements, one or more groups of LED elements will remain deactivated.

In particular, a dimmed supply voltage may be supplied, where the entire wave form, e. g. sinusoidally varying AC voltage, is modified by phase cut operation, such as e. g. by a leading edge (LE) or trailing edge (TE) phase cut dimmer. The thus modified waveform will be supplied to the step driver after rectification. In particular in strongly dimmed operation, some LED elements in the lighting device may be operated only for a very short time during each period, or may even remain deactivated throughout the entire period.

The inventors have recognized that the optical appearance of the lighting device, especially when dimmed down, has not previously been sufficiently considered. Deactivated LED elements and in particular large clusters of LED elements simultaneously deactivated may appear individually visible, such that the dimmed lighting device may be perceived as a partially activated/deactivated arrangement pattern of individual LED elements or clusters thereof.

The lighting device according to the invention comprises a plurality of LED elements connected to form at least two groups of LED elements. “LED element” may be any type of solid state lighting element, such as in particular semiconductor light emitting diodes, OLEDs, etc. Preferably, the LED elements are provided in packaged form, i. e. as separately connectable components. Particularly preferred is the use of high voltage LEDs with an operating voltage of at least 10 V, preferably at least 20 V. In particular, multijunction LED packages are preferred, such as e. g. with 24 or 48 V nominal voltage.

Each of the at least two groups comprises at least a series connection of at least two LED elements. As will become apparent in connection with preferred embodiments, the LED elements of each group may all be connected in series. Alternatively, within a group, two or more strings (series connections) of LED elements may be electrically connected in parallel.

The number of LED elements in one group may e.g. be 2-30, preferably 2-12. The number of LED elements may vary between the groups. It may be preferred that at least one of the groups comprises at least three LED elements, further preferred at least four, five or six LED elements. The group with the most LED elements may be the first group, which is activated in a first stage as will be explained below. Remaining groups may comprise fewer LED elements.

The number of groups of LED elements connected to the step driver circuit may vary. For example, there may be 2-6 groups, further preferred 3 or 4 groups which each comprise at least one string of LED elements. In some embodiments, there may be one or more further groups where LED elements are not connected in series, such as e. g. if in one additional group there is only one single LED element present.

The groups of LED elements are all electrically connected to a step driver circuit. The step driver circuit is disposed to receive electrical power in the form of a periodically varying supply voltage. The step driver circuit is comprised of electrical components connected so as to automatically activate or deactivate entire groups of LED elements depending on a momentary voltage value of this supply voltage.

By thus choosing activated groups of LED elements depending on the momentary supply voltage, the step driver may directly deliver the supply voltage to the activated groups, which are preferably electrically connected in series. Further preferably, taps connected to the step driver circuit are arranged in the series connection between the groups, such that the step driver may activate the groups by connecting the supply voltage thereto. For example, the step driver may activate the groups in one or more stages, such that e. g. in a first stage only a first group is activated, and in a second stage the first group is activated simultaneously with at least one further group. In an example with three groups, only the first group is activated in a first stage, first and second group are activated in the second stage, and all three groups are activated in the third stage. Of course the same concept may be applied to other configurations, such as e.g. with four or more groups.

Activation of the groups depending on the momentary voltage value may be such that for each stage there is an associated threshold for the supply voltage. The step driver circuit operates e.g. such that it activates none of the groups if the momentary supply voltage is below a first threshold, and activates only a first group of LED elements if the momentary supply voltage is above the first threshold but below a second threshold, activates the first group simultaneously with a second group if the momentary supply voltage is above the second threshold, etc.

In the lighting device according to the invention, the LED elements are arranged on a carrier to form an arrangement pattern. The carrier may be any structure suited to hold the LED elements in place, and may be a body of any shape suitable therefore. In particular, the carrier may comprise a curved or preferably plane surface, on which the arrangement pattern is formed. Preferably, the arrangement pattern is comprised of all LED elements connected to the step driver circuit.

According to the invention, the LED elements of at least one of the groups are located on the carrier so as to be evenly distributed over the arrangement pattern. This has the optical effect that if only this group is activated, the emitted light appears evenly distributed over the arrangement pattern.

An even distribution of LED elements is understood such that the arrangement pattern, if only LED elements from this group are activated, does not comprise either dark areas (i. e. with a plurality of adjacent deactivated LEDs) or bright areas (i. e. with a plurality of adjacent activated LED elements) of significant size relative to the overall size of the arrangement pattern. For example, a group of LED elements that covers a continuous area of adjacent LED elements to one side of the total arrangement pattern, e. g. one half thereof, would not be evenly distributed.

As one example, an evenly distributed arrangement may be provided by LED elements located in an interleaved arrangement, i. e. with LED elements or clusters (a small number of LED elements of the same group provided adjacently, e. g. two, three or four LED elements together) of one group are provided spaced from each other with LED elements from other groups arranged in between. Further preferred the elements or clusters are evenly spaced.

An even distribution may be achieved already with a relatively small number of LED elements, as will become apparent from preferred embodiments, with four or five LED elements. An even distribution, however, may be more easily achieved with a larger total number of LED elements in the overall arrangement pattern, such as with at least six LED elements, preferably at least eight LED elements.

The evenly distributed arrangement of the LED elements from at least one of the groups has the advantage of maintaining an optical appearance that may allow for the user to perceive the entire lighting device, even in a dimmed state, as still emitting light over substantially the entire arrangement pattern, without individual LED elements becoming apparent. This particularly applies if the first group of LED elements, i. e. the group that will stay activated even when strongly dimmed, is provided evenly distributed. The effect will further be stronger if more than one group is provided evenly distributed over the entire arrangement pattern. For example, if at least of two groups are located on the carrier so as to be evenly distributed over the arrangement pattern, this allows to maintain a preferred appearance not only in one dimmed state, but in several dimmed states, in particular those where only one or more of the evenly distributed groups are activated.

According to a preferred embodiment of the invention, the LED elements of at least one group, in particular preferred of a group where the LED elements are evenly distributed over the arrangement pattern, may be located on the carrier in a symmetrical group pattern. This is particularly effective if at least the first group is symmetrical. Thus, the LED elements of at least one, preferably a plurality of groups, and alternatively or additionally also of the overall arrangement pattern may be arranged symmetrically. For one group, but also for all other arrangements according to this invention where symmetry is preferred, this may include different types of symmetry, such as e. g. mirror symmetry with regard to at least one axis, preferably at least two or more axes or rotational symmetry. In particular, it is preferred that the group pattern of at least one, preferred more than one group and/or overall arrangement pattern has a rotational symmetry of less than 180°. As will become apparent in connection with preferred embodiments, rotational symmetry of e. g. 90° or less may particularly be preferred.

In one exemplary embodiment, the arrangement pattern may comprise LED elements arranged to form at least one full or partial circle. A circle as an arrangement of high symmetry may provide a preferable appearance. While a full circle may be preferred, in some embodiments LED elements may also be arranged in a partial circle, e. g. to provide space for connection wiring, driver electronics etc. Preferably, the partial circle extends over at least 270°. Over the circle or partial circle thus formed, the LED elements from at least one group, but preferably from more than one group may be evenly distributed. The entire arrangement pattern may be comprised of the circle, but alternatively further LED elements may be provided, e.g. placed within the circle.

In a particularly preferred embodiment where the arrangement pattern comprises at least one full or partial circle, LED elements arranged along this circle may belong to at least two different groups, and are then preferably arranged in an interleaved manner. An interleaved arrangement in this case is understood such that along the circle LED elements (or clusters thereof) alternately belong to different groups. This allows to provide a particularly even distribution.

For groups connected to the step driver to be driven in stages as explained above, it is particularly preferred that in at least two of these stages the activated LED elements form a symmetrical pattern on the carrier. Preferably, this applies at least to the lowest active stage (only one group activated), and to the highest stage (all groups activated). It is further preferable if also in intermediate stages the activated LED elements form a symmetrical pattern. For example, in the first stage and in the highest stage a rotational symmetry may be provided, whereas in at least one intermediate stage there is at least a mirror symmetry.

According to a further preferred embodiment of the invention, LED elements from at least one of the groups are disposed to emit light of a color temperature different from LED elements of another of the groups. As one preferred example, all or at least a part of the LED elements from the first group may have a warmer color temperature than the LED elements from at least one further group to provide an automatical dim tone functionality, where the overall color temperature gets warmer in a more strongly dimmed state. If elements within one group differ in color temperature, it is particularly preferred to arrange those LED elements with a common color temperature evenly distributed and/or symmetrically within the group pattern.

Further preferred embodiments relate to the electrical circuit formed by the LED elements and the step driver circuit. As already explained above, the groups are preferably electrically connected in series. Taps may be arranged in this series connection between the groups, and may be connected to the step driver circuit. At least one capacitive element may be connected in parallel to each of the groups. Between the groups, diode elements, such as regular (non light emitting) semiconductor diodes may be provided electrically to separate the groups.

These and other aspects of the invention will become apparent from and elucidated with reference to the embodiments described hereinafter.

### BRIEF DESCRIPTION OF THE DRAWINGS

In the drawings,

FIG. 1 shows a circuit diagram of a first embodiment of a lighting device;

FIGS. 2a-2c show the arrangement of groups of LED elements of the lighting device of FIG. 1;

FIG. 3 shows a circuit diagram of a second embodiment of a lighting device;

FIGS. 4a-4c show the arrangement of groups of LED elements of the lighting device of FIG. 3;

FIGS. 5a-5c, 6a-6c show arrangement of LED elements according to a third and fourth embodiment;

FIG. 7 shows a circuit diagram of a lighting device according to the embodiment of FIGS. 5a-5c, 6a-6c;

FIGS. 8a, 8b show an arrangement of LED elements and a circuit diagram for a fifth embodiment of a lighting device;

FIGS. 9a, 9b; 10a, 10b; 11a, 11b; 12a, 12b; 13a, 13b; 14a, 14b each show the arrangement of LED elements and circuit diagram of lighting devices according to a sixth, seventh, eighth, ninth, tenth, and eleventh embodiment;

FIGS. 15, 16 show an arrangement of LED elements according to a twelfth and thirteenth embodiment;

FIGS. 17a, 17b; 18a, 18b; 19a, 19b; 20a, 20b each show arrangement of LED elements and circuit diagrams for a fourteenth, fifteenth, sixteenth and seventeenth embodiment of a lighting device.

### DESCRIPTION OF EMBODIMENTS

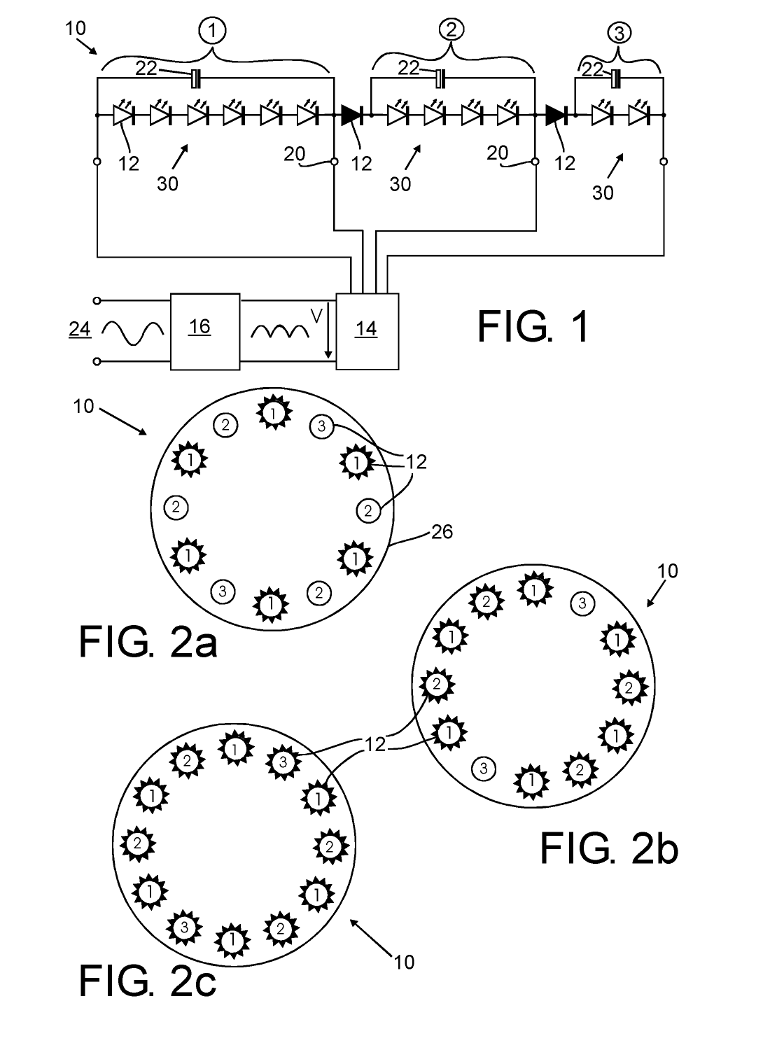

FIG. 1 shows a circuit diagram of a first embodiment of a lighting device 10. The lighting device 10 comprises a plurality of LED elements 12 connected to a step driver circuit 14.

The LED elements 12 are electrically connected in groups, in the example shown a first group 1, second group 2, and third group 3. In the exemplary circuit shown, all LED elements 12 within each group are electrically connected as LED strings 30, i. e. as series connections of multiple LED elements. In the example of FIG. 1, a first group 1 comprises a string 30 of six LED elements 12, the second group 2 comprises a string 30 of four LED elements 12, and the third group 3 comprises a string 30 of two LED elements 12.

The strings and thus LED elements 12 from all three groups 1, 2, 3 are electrically connected in series.

In the preferred embodiment, the individual LED elements 12 are multijunction LED packages, for example with a nominal voltage of 24 V each.

The groups 1, 2, 3 are connected to the step driver circuit 14 in a tapped linear driver (TLD) architecture. Between the groups, which are electrically separated by (non light emitting) diodes 18, taps 20 are provided, connected to the step driver circuit 14. Each group is electrically stabilized by a parallel capacitor 22.

The lighting device 10 is powered by mains electrical power 24, rectified by a rectifier 16 and supplied to the step driver circuit 14.

The step driver circuit 14 selectively activates the groups 1, 2, 3 depending on the momentary voltage value of the thus rectified voltage V.

As generally known to the skilled person from TLD architectures, the step driver circuit 14 compares the momentary voltage V to several thresholds and activates the groups 1, 2, 3 in several stages depending on this comparison. In the present example, the first group 1 with six LED elements 12 of 24 V nominal voltage requires a minimum voltage of 144 V for operation. As long as a rectified voltage supplied to the step driver circuit 14 is below this value, all LED elements 12 remain deactivated. As the voltage exceeds the first threshold at 144 V, but is still below a second threshold of 240 V (144 V for the six LEDs in group 1+96 V for the four LEDs in group 2), in a first stage only the first group 1 is activated. Above 240 V but below 288 V, the first and second groups are activated in a second stage. Finally, above 288 V, all three groups are simultaneously activated in a third stage.

Accordingly, if a sinusoidal supply voltage is supplied to the step driver circuit 14 in rectified form, the groups 1, 2, 3 of LED elements 12 will continuously be turned on one after the other. While the first group 1 of LED elements 12 will be activated for longer periods of time than the other groups 2, 3, all groups will be activated for a certain period of time in each period of the supply voltage.

If a dimmer is used, the waveform of the originally sinusoidal supply voltage will be modified according to the type of dimmer, e.g. by a phase cut for a LE (leading edge) or TE (trailing edge) dimmer. Depending on the resulting phase cut waveform, the groups 1, 2, 3 will not always be activated consecutively as for an unmodified sinusoidal supply voltage. For example, depending on the dim level, the second group 2 and in particular the third group 3 may only be activated for shorter periods, or the rectified voltage supplied to the step driver circuit 14 may not reach a level high enough to activate them at all. Thus, depending on the dim state, the LED elements in particular of the second and third groups 2, 3, will appear darker (due to the shorter duration of the periods of activation) or even entirely dark.

As the skilled person will understand, besides the described specific example of a TLD architecture different embodiments may be used, some of which will be described below. In each case, the individual groups of LED elements 12 will be selectively activated depending on the momentary value of the rectified voltage. Activation will occur in stages, such that in a first stage only the first group is activated, in a second stage the first and second groups are activated, etc., until in the highest stage all groups are simultaneously activated. Since circuits are generally known to the skilled person to realize this function, no further details of the step driver circuit will be explained here.

The lighting device 10 is, for example, an LED lamp of the type GU10PF. In the example, the 12 LED elements 12 are arranged on a flat printed circuit board 26 as carrier. FIG. 2a schematically shows the placement of the individual LED elements 12 on the PCB 26. Each LED element 12 is shown only schematically as a circle with the number of the group it belongs to. In FIG. 2 and the following drawings used for schematically illustrating placement of the LED elements 12, all wiring and further circuitry is omitted for clarity reasons.

The LED elements 12 on the PCB 26 together form an arrangement pattern. In the first embodiment, the arrangement pattern is a circle, with the LED elements 12 arranged along the circle line.

As shown in FIG. 2a, the LED elements 12 from the first group 1 are evenly distributed over the arrangement pattern, i. e. over the formed circle. The LED elements 12 from the first group 1 are placed within the arrangement pattern in interleaved manner, i. e. every other of the LED elements 12 belongs to the first group 1, such that the individual LED elements from the first group 1 are evenly spread and always separated by an LED element of one of the other group.

The four LED elements of the second group 2 are also evenly distributed over the circle. The LED elements from the second group are also arranged in interleaved manner, although in this case the distances between are not in each case equal as for the first group.

The overall arrangement pattern of the LED elements 12 in the first embodiment is symmetrical. As will be easily recognized, a plurality of different mirror axes may be defined with respect to which the arrangement pattern exhibits mirror symmetry. Further, the arrangement pattern is rotationally symmetrical for rotational angles of 30°, 60°, 90° etc. Thus, the overall arrangement pattern has a high degree of symmetry.

Also, the group pattern formed by the LED elements 12 of the first group 1 is also symmetrical. As will be easily recognized, the LED elements 12 from the first group 1 are arranged in a group pattern with multiple mirror symmetries and rotational symmetries of 60°, 120°, etc.

FIG. 2a shows the lighting device 10 in the first stage of activation, where only LED elements from the first group 1 are activated (designated by surrounding arrows). Thus, FIG. 2a gives an impression of the appearance of the lighting device 10 in a strongly dimmed state. As visible, the even distribution of the activated LED elements 12 within the arrangement pattern, and the high symmetry of the activated LED elements 12 achieves a well-balanced optical appearance.

FIGS. 2b, 2c show the second and third activation stage of the lighting device 10.

In the second, intermediate stage shown in FIG. 2b, the activated LEDs 12 of groups 1 and 2 form a pattern which is still relatively evenly distributed over the entire arrangement pattern, with only the two LED elements 12 from the third group 3 deactivated. Further, the activated LEDs even in the second, intermediate stage are arranged symmetrically (although to a lesser degree), i. e. with a mirror symmetry with regard to one axis.

In the third and highest activation stage shown in FIG. 2c, all LED elements 12 are activated, forming again a highly symmetrical pattern. Thus, overall, the lighting device 10 according to the first embodiment achieves a favorable optical appearance in all dim states, and in particular in the lowest dim state (first stage, FIG. 2a) and in the highest dim state (third stage, FIG. 2c) due to an evenly distributed and symmetrical arrangement.

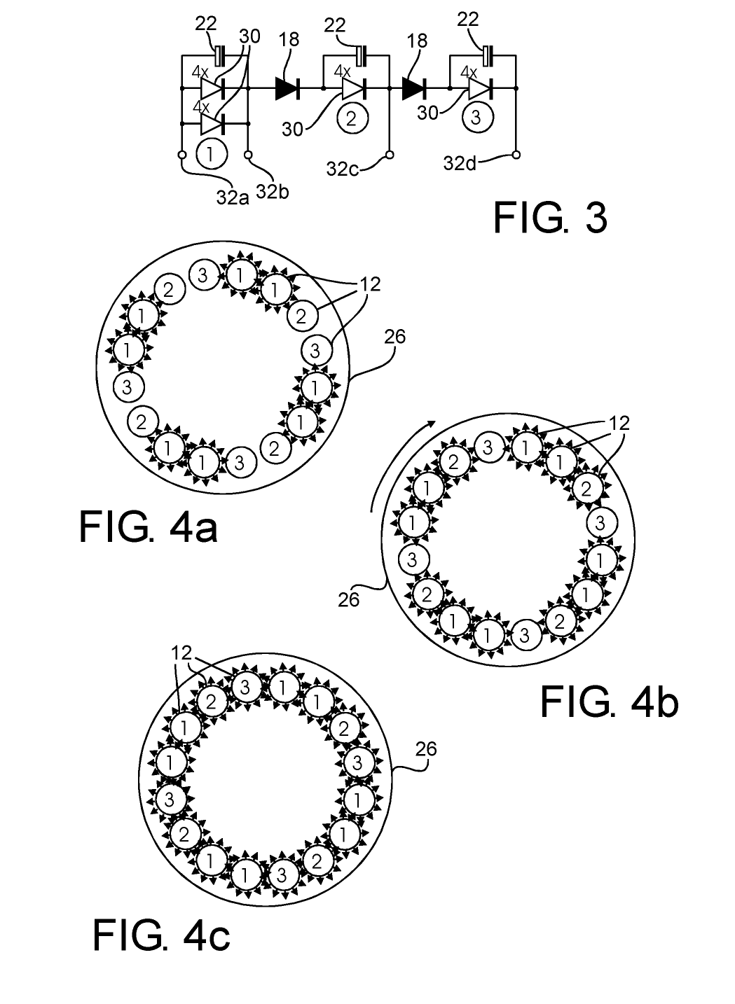

FIG. 3 shows a partial circuit diagram of a second embodiment of a lighting device. The circuit shown is of the same structure as that of FIG. 1 with strings 30 of LED elements arranged in a TLD architecture only with a different arrangement of LED elements within each group, leading to a different number of LED elements 12. The embodiment comprises altogether 16 LED elements 12 which are not shown individually but only in strings 30 (series connections of individual LED elements). In FIG. 3 and in the following FIGS., the number of individual LED elements within each string is indicated next to the corresponding symbol, e.g. “4×” in FIG. 3 signifying that each string 30 is comprised of four LED elements. As in the first embodiment, each group 1, 2, 3 comprises a parallel capacitor 22 and the groups 1, 2, 3 are all arranged electrically connected in series separated by diodes 18. In the second embodiment as well as in further embodiments, same reference numerals designate same elements.

In FIG. 3, the step driver circuit 14 has been omitted and only the taps 32a, 32b, 32c, 32d which would be connected thereto, are shown for clarity reasons.

In the electrical circuit according to the second embodiment, the first group 1 is comprised of two strings 30 connected in parallel. The 16 LED elements each have a nominal voltage of 24 V. Since in the first group 1 strings of four LED elements series are provided, the first threshold is 4×24 V=96 V. The second threshold is 192 V and the third threshold 288 V.

FIG. 4a shows the arrangement of LED elements from the first group 1, second group 2 and third group 3. Arrows signifying activated LED elements illustrate the optical appearance in FIG. 4a for the first stage, 4b for the second stage and 4c for the third stage.

In this embodiment, the LED elements 12 are arranged in an overall arrangement pattern of a circle on a flat printed circuit board 26. This overall arrangement pattern has a high degree of symmetry, both rotational symmetry and mirror symmetry with regard to multiple axes.

The LED elements 12 from the first group 1 are evenly distributed over the circular arrangement pattern. The LED elements from the first group 1 are arrangement in interleaved manner along the circle line. However, contrary to a first embodiment, the interleaved arrangement is not formed of individual LED elements 12, but of small clusters, each formed of two LED elements. Along the circle line, the clusters are evenly spaced, leaving two LED elements 12 from other groups in-between. Thus, an even distribution is achieved, yielding a favorable appearance even in the lowest dim state (FIG. 4a).

The arrangement of LED elements of the first group 1 is also symmetrical, in this case with rotational symmetry of 90° and mirror symmetry with regard to multiple axes.

The LED elements 12 from the second group 2 are also evenly spaced over the circle line in an interleaved manner. The group pattern of the second group thus formed is also symmetrical. In the second stage (FIG. 4b) the activated LED elements 12 form an evenly distributed, highly symmetrical pattern.

Comparing the pattern of activated LED elements 12 in the first stage (FIG. 4a) and second stage (FIG. 4b), the symmetry axes are rotated slightly as the pattern changes from the first to the second stage. This is indicated by the arrow shown in FIG. 4b.

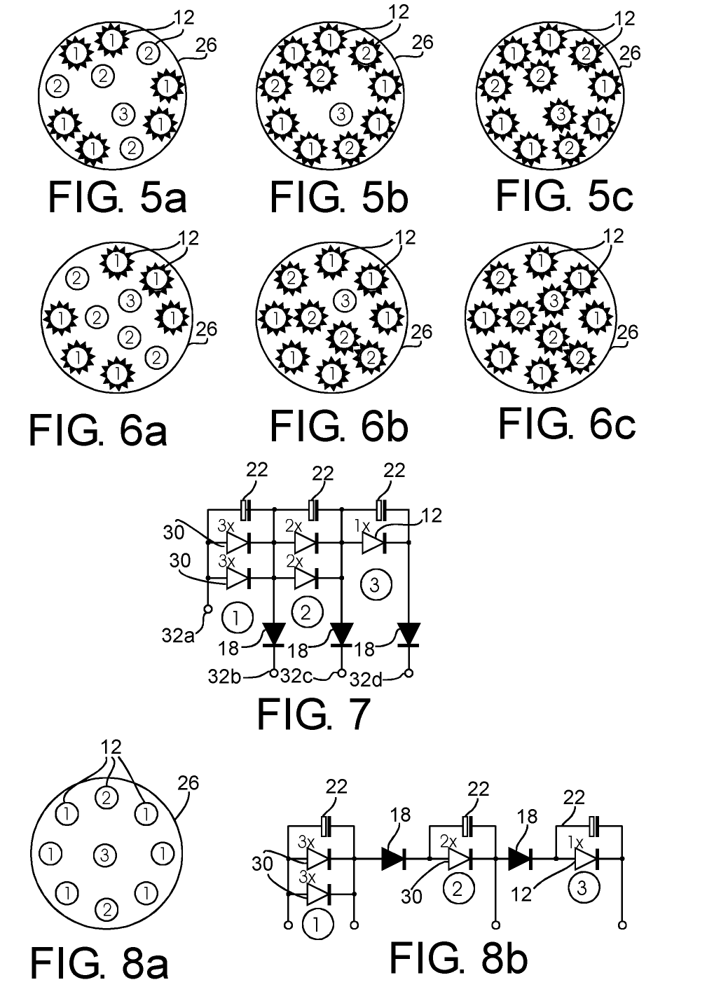

FIGS. 5a-5c show a further embodiment of LED elements 12 arranged on a PCB 26. The overall arrangement pattern is a circle with two additional LED elements placed within the circle. As visible from the FIGS., the LED elements 12 from the first group 1 are evenly distributed over the circle in equally spaced interleaved manner along a circle line. The arrangement of at least this first group is highly symmetrical. The overall arrangement pattern has a lesser degree of symmetry but at least shows mirror symmetry with regard to one axis.

FIG. 7 shows a corresponding circuit diagram for the six LED elements 12 within the first group, four LED elements 12 in the second group 2 and an additional single LED element 12 in a third group. The circuit design slightly differs from the previous embodiments in that the diodes 18 are not connected in the series connection of the groups 1, 2, 3 but between the groups and the taps 32b, 32c, 32d.

FIGS. 6a-6c show an arrangement of LED elements 12 on a PCB 26 according to a fourth embodiment. The 11 LED elements 12 with six LED elements 12 in the first group 1, four LED elements 12 in the second group 2 and a single LED element 12 in the third group 3 may be arranged also in the circuit as shown in FIG. 7. For example, each LED element 12 may be an 48 V multijunction LED package.

The arrangement of LED elements 12 from the first group, as shown in FIGS. 6a-6c, is evenly spaced with two three-element clusters arranged in interleaved manner along a circle.

A circuit diagram and an arrangement pattern of LED elements 12 on a PCB 26 according to a fifth embodiment are shown in FIG. 8a, 8b. A total of nine elements 12 are arranged in an overall highly symmetrical arrangement. Six LED elements 12 from the first group 1 (two parallel strings of three LED elements each) are arranged on a circle.

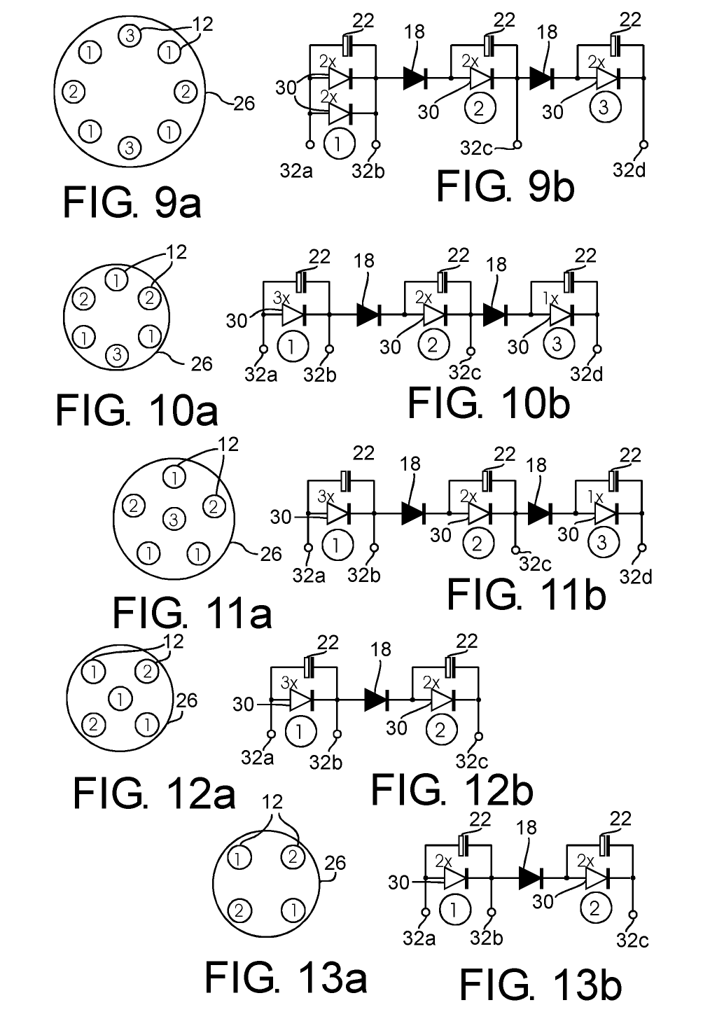

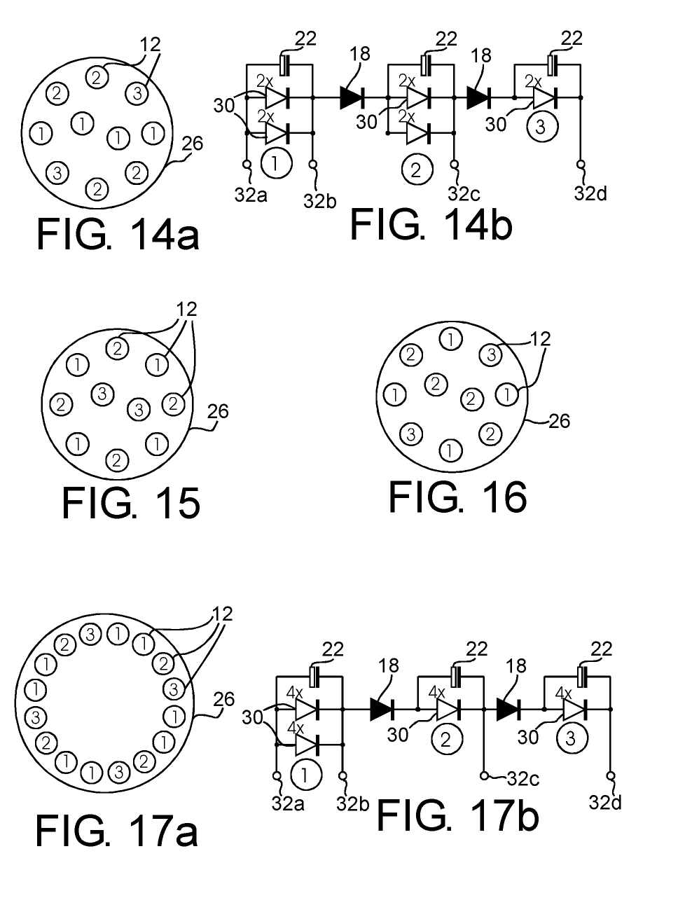

FIGS. 9a, 9b, 10a, 10b, 11a, 11b, 12a, 12b, 13a, 13b, 14a, 14b show further embodiments. FIGS. 15, 16 show still further embodiments with different arrangements of ten LED elements 12 on the PCB 26, which may be supplied by the circuit shown in FIG. 14b.

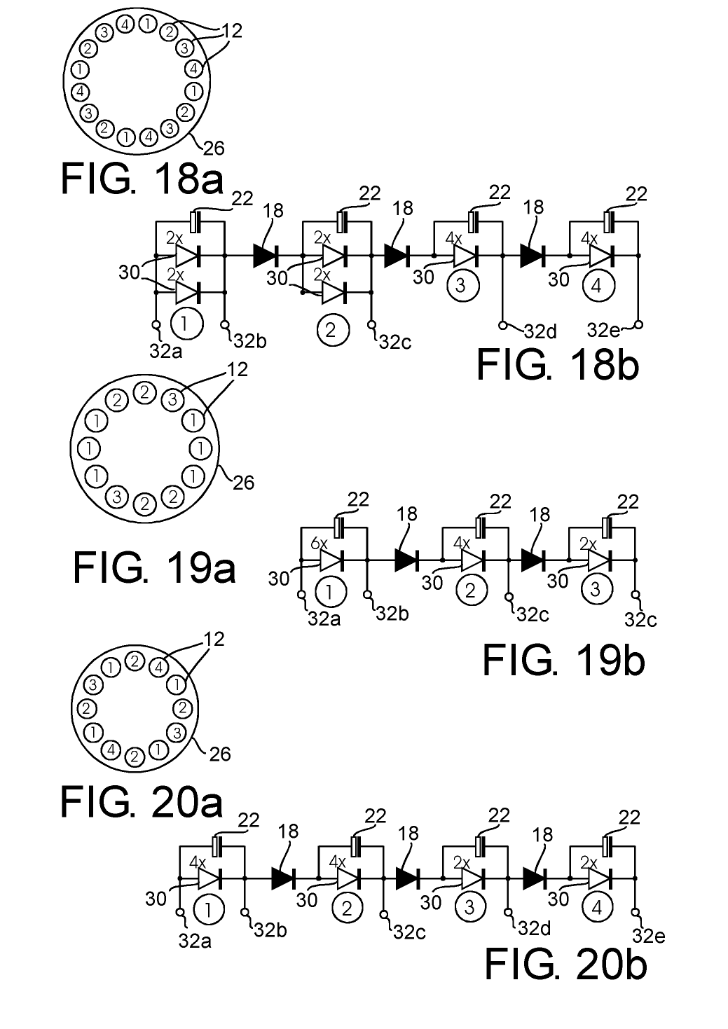

Still further embodiments are shown in FIGS. 17a, 17b, 18a, 18b, 19a, 19b and 20a, 20b. As particularly visible from the embodiments of FIGS. 18a, 18b and 20a, 20b, the LED elements 12 may also be arranged in four groups 1, 2, 3, 4.

The invention has been illustrated and described in detail in the drawings and foregoing description. Such illustration and description are to be considered illustrative or exemplary and not restrictive; the invention is not limited to the disclosed embodiments.

For example, different embodiments of circuit designs may be used for the disclosed arrangements of LED elements.

In the claims, the word “comprising” does not exclude other elements, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. Lighting device comprising
a plurality of LED elements electrically connected to form at least two groups, wherein each group of LED elements comprises at least one string of at least two LED elements; electrically connected in series,
a step driver circuit for supplying electrical power to said LED elements, said step driver circuit being disposed to operate said groups of LED elements from a periodically varying supply voltage (V) by activating said groups selectively depending on a momentary voltage value of said supply voltage (V),
wherein said LED elements are arranged on a carrier forming an arrangement pattern,
and wherein the LED elements, of at least one of said groups are located on said carrier so as to be evenly distributed over said arrangement pattern.

2. Lighting device according to claim 1, wherein
the LED elements of said one group are located on said carrier in a symmetrical group pattern.

3. Lighting device according to claim 2, wherein
said group pattern has a rotational symmetry of less than 180°.

4. Lighting device according to claim 1, wherein
said step driver is disposed to activate said groups, depending on said momentary value of said supply voltage (V), in two or more stages, wherein in a first stage only a first group is activated, and in a second stage said first group is activated simultaneously with at least one further group.

5. Lighting device according to claim 4, wherein
the LED elements from said first group are evenly distributed over said arrangement pattern.

6. Lighting device according to one of claim 4, wherein
in at least two of said stages the activated LED elements form a symmetrical pattern on said carrier.

7. Lighting device according to claim 1, wherein
said LED elements of at least one group are located within said arrangement pattern in an interleaved arrangement, where LED elements or clusters of LED elements of one group are provided spaced from each other with LED elements from at least one other group arranged in between.

8. Lighting device according to claim 1, wherein
the LED elements 42 of at least two of said groups are located on said carrier so as to be evenly distributed over said arrangement pattern.

9. Lighting device according to claim 1 wherein
said arrangement pattern comprises LED elements arranged to form at least one full or partial circle,
wherein said LED elements from at least one of said groups are evenly distributed over said circle.

10. Lighting device according to claim 1, wherein
said arrangement pattern comprises LED elements arranged to form at least one full or partial circle,
wherein said LED elements in said circle comprise LED elements from at least two of said groups arranged in interleaved manner.

11. Lighting device according to claim 1, wherein
LED elements from at least one of said groups are disposed to emit light of a color temperature different from LED elements of another of said groups.

12. Lighting device according to claim 1, wherein
said groups are electrically connected in series,
and taps arranged in said series connection between said groups are connected to said step driver circuit.

13. Lighting device according to claim 1, wherein
at least one capacitive element is connected in parallel to each of said groups.

14. Lighting device according to claim 1, wherein
at least one diode element is connected between at least two of said groups.

15. Method of operating a lighting device, said lighting device comprising a plurality of LED elements arranged on a carrier to form an arrangement pattern, said LED elements being electrically connected to form at least two groups, wherein each group of LED elements comprises at least one string of at least two LED element connected in series, and wherein the LED elements of at least one of said groups are located on said carrier so as to be evenly distributed over said arrangement pattern,
said method comprising supplying said groups of LED elements with electrical power from a periodically varying supply voltage (V) by activating said groups selectively depending on a momentary voltage value of said supply voltage.
